(19) United States
(12) Patent Application Publication
(10) Pub. No.: US 2026/0246292 A1
(43) Pub. Date: Aug. 20, 2026

(54) METHOD FOR FAST CHARGING OF A BATTERY

(71) Applicant: Pavel Masliakov, Haifa (IL)

(72) Inventors: Makich Danielyan, Moscow (RU); Pavel Masliakov, Haifa (IL)

(21) Appl. No.: 19/534,213

(22) Filed: Feb. 9, 2026

Related U.S. Application Data
(60) Provisional application No. 63/760,462, filed on Feb. 19, 2025.

(51) Int. Cl. H02J 7/90; H01M 10/44; H02J 7/65; H02J 7/82; H02J 7/94; H02J 7/96

(52) U.S. Cl. CPC H02J 7/927; H01M 10/44; H02J 7/65; H02J 7/82; H02J 7/94; H02J 7/96

(57) ABSTRACT

A pulsed-charging system and method for rapidly charging a battery with reduced heat generation and minimized electrochemical degradation are disclosed. Electrical energy is delivered to the battery as a sequence of high-voltage, low-current pulses generated by discharging a buffer-capacitor module through an electronic switching element. Each pulse is terminated when a first derivative of charging current (dI/dt) approaches zero, indicating transient current stabilization. A pause interval follows, during which energy delivery is suspended until a first derivative of battery terminal voltage (dV/dt) approaches zero, indicating ionic and voltage relaxation. The pulse-pause sequence is repeated until the battery reaches a target state of charge. The system maintains substantially constant pulse voltage using buffer capacitors and may include an output-capacitor bank at the battery terminals. The disclosed technique enables rapid full-capacity charging while operating at significantly reduced average current, resulting in substantial thermal reduction, improved safety, and extended battery life compared to conventional high-current fast-charging methods.

### CROSS-REFERENCE TO RELATED APPLICATIONS

This application is a non-provisional patent application claiming the benefit of priority under 35 U.S.C. § 119(e) to U.S. Provisional Patent Application No. 63/760,462, filed on Feb. 19, 2025, entitled “METHOD FOR FAST CHARGING OF A BATTERY,” the entire contents of which are hereby incorporated by reference in its entirety.

### BACKGROUND

The present invention relates generally to the field of electrical energy storage and power management, and more particularly to methods for fast charging of rechargeable batteries such as lithium-ion batteries used in electric vehicles and other high-capacity applications.

The problem of fast charging of lithium-ion batteries remains highly relevant, especially in the context of the rapidly growing market for electric transport. For over a century since the advent of mass motorization, consumers have been accustomed to spending no more than approximately five minutes refueling a vehicle equipped with an internal combustion (IC) engine. Consequently, in the ongoing transition from IC engines to environmentally friendly electric propulsion systems, it is of critical importance to develop a charging method that provides a comparable experience in terms of time and convenience.

Existing high-power charging stations typically charge an electric vehicle battery within 30 to 40 minutes under optimal conditions. Moreover, such stations usually do not restore the battery to full capacity; instead, they commonly achieve only about 80% charge, and only when the initial state of charge is above a threshold such as 10%. At high charging currents, battery cells experience significant heating, despite the presence of integrated cooling systems. This temperature rise accelerates degradation of cell chemistry and reduces long-term battery life.

A further and persistent challenge is the inability of existing systems to restore a full 100% charge expeditiously. Current fast-charging approaches emphasize rapid replenishment of only the initial portion of the battery, typically the first 60-80%, because higher states of charge result in increased cell impedance, elevated heat generation, and heightened risk of lithium plating. As the battery voltage climbs, charging naturally shifts from a constant-current phase to a constant-voltage (CV) phase in which the charging current tapers sharply. This “tapering effect” substantially prolongs the final stage of charging and prevents present-day systems from delivering a full charge within a time frame comparable to IC-engine refueling.

The practical implications of this limitation are significant. Inability to achieve full capacity in a short time forces EV drivers to plan trips around longer charging stops or to accept reduced driving range when relying only on partial charges. That, in turn, contributes to consumer “range anxiety,” reduces operational uptime for commercial fleets, and imposes inefficiencies on logistics and emergency-service operations. Repeated use of partial-charge cycles instead of full charges may also increase the frequency of battery-balancing procedures or cause non-uniform aging of individual cells within the battery pack.

Achieving a true full charge from 0% to 100% within 5 to 10 minutes represents an unmet technical objective. The barriers to achieve this objective are, for example, the sharp rise in internal resistance as the state of charge increases, nonlinear diffusion and ion-transport limitations within the electrodes, and unavoidable heat generation due to high charging currents passing through resistive cell components. Contemporary solutions focus on modifying battery design to reduce internal resistance, adopting new electrode materials, or improving thermal management. However, even with these improvements, high-current charging still produces thermal stress and causes irreversible degradation, making such approaches insufficient for enabling rapid, full-capacity charging.

Accordingly, there exists a need for an improved charging method capable of providing a complete and rapid restoration of battery capacity while keeping the battery temperature within safe limits and preventing degradation. The present invention addresses this need by introducing a charging approach that enables fast, efficient, and thermally stable full-capacity charging of lithium-ion batterie.

### SUMMARY

The present invention provides a system and method for fast charging of a rechargeable battery while significantly reducing heat generation and electrochemical degradation. Conventional fast-charging approaches rely on high-current constant-current delivery, which produces substantial resistive heating and shortens battery life. In contrast, the disclosed invention transfers energy using a series of controlled high-voltage, low-current pulses that are adaptively terminated based on real-time measurements of the battery's electrical response.

In one aspect, the invention provides a pulsed-charging system including an external electrical-energy source, a buffer-capacitor module configured to store and release energy as high-voltage pulses, an electronic switching element for applying the pulses to the battery, and a controller that monitors both the first derivative of charging current (dI/dt) and the first derivative of battery voltage (dV/dt). A charging pulse is terminated when dI/dt approaches zero, indicating stabilization of transient current flow, and a pause interval is terminated when dV/dt approaches zero, indicating voltage relaxation within the battery. This adaptive sequence ensures energy is supplied only during periods of efficient charge acceptance.

In another aspect, the invention provides a method for charging a battery that includes delivering high-voltage pulses formed by discharging the buffer-capacitor module through the switching element, terminating each pulse based on dI/dt behavior, pausing energy delivery until dV/dt stabilizes, and repeating the pulse-pause sequence until a target state of charge is reached. The method maintains pulse-voltage stability using buffer capacitors and may optionally include an output-capacitor bank connected in parallel with the battery to smooth transient voltage fluctuations.

The system and method allow energy to be transferred at higher voltages and substantially lower average currents than conventional fast charging. As a result, heat generation is dramatically reduced, battery degradation is minimized, and charging speed is significantly increased. Experimental validation demonstrates that the disclosed pulsed-charging technique can achieve full charging cycles with only minimal temperature rise and negligible long-term capacity fade, making the invention particularly suitable for electric-vehicle battery packs, grid-storage systems, and other applications requiring rapid and thermally stable charging.

### BRIEF DESCRIPTION OF THE DRAWINGS

In order that the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, aspects of the invention will be described and explained with additional specificity and detail through the use of the accompanying drawings.

FIG. 1 depicts a system for a pulsed-charging system for a rechargeable battery according to embodiments of the invention;

FIG. 2 depicts a graph of test results for the pulsed-charging system for a rechargeable battery according to embodiments of the invention;

FIG. 3 depicts a flow diagram illustrating a method of operating the pulsed-charging system according to embodiments of the invention.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the excellent results of the present invention. Therefore, the following description shall be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

For illustrative purposes, considering a lithium-ion battery having a nominal capacity of approximately 2.5 Ah and a nominal operating voltage of 3.7 V. In conventional fast-charging systems, to deliver a full charge of 2.5 Ah within approximately ten minutes, an average charging voltage of approximately 4 V is applied, requiring a charging current of about 15 A (i.e., approximately 6 C). Such high current levels inevitably result in substantial resistive heating within the battery cells, even when cooling systems are employed. This in turn, leads to degradation of the electrochemical components and reduced long-term battery life.

In contrast, according to embodiments of the present invention, the method allows energy to be transferred at a higher average charging voltage, for example, approximately 20 V, while reducing the required average current to as little as 3 A. Under the law of conservation of energy, approximately 0.5 Ah is delivered at 20 V yields, which is the same energy transfer as 2.5 Ah delivered at 4 V. Accordingly, the method according to the present invention, performs charging with approximately one-fifth the current otherwise required, resulting in at least three times less heat generation, because resistive heating is proportional to the square of the charging current (I²R). This substantial thermal reduction directly improves charging safety, minimizes cell degradation, and prolongs battery life.

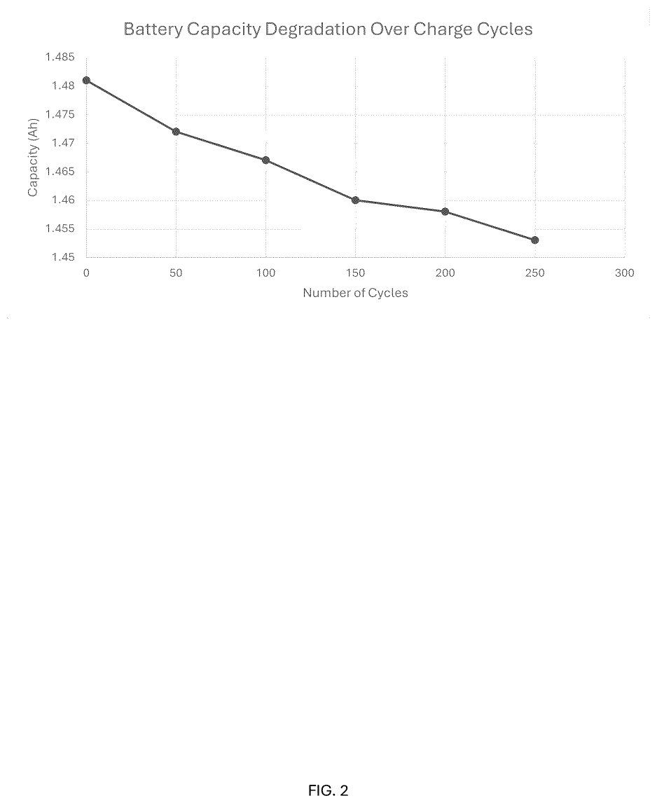

The foregoing numerical example is provided solely to illustrate the functional principles of the invention. In practice, the charging method has been applied to numerous charge-discharge cycles for evaluation. The test results, shown below (FIG. 2) indicate that, when charged using the methods of the present invention, the temperature of the battery increased by only approximately 12° C. after a full charging cycle. This is significantly lower than temperature increases observed with conventional charging methods at equivalent energy transfer rates.

According to embodiments of the invention, electrical energy is supplied to a battery in the form of energy pulses. Each pulse is delivered for a specific duration and at a controlled voltage level, with energy transfer continuing until a defined dynamic condition is met. In some embodiments, the end of each pulse occurs when a first derivative of the pulse current with respect to time (dI/dt) reaches approximately zero. A zero derivative indicates that the transient charge-absorption response of the battery has stabilized for that pulse interval.

Pulse-based energy transfer reduces instantaneous current demands and allows the battery to equalize voltage and internal ion distribution between pulses. This process mitigates thermal buildup, improves charge acceptance, and reduces the risk of lithium plating or other undesirable side reactions.

To maintain a substantially constant pulse voltage during energy transfer, one or more buffer capacitors are connected in parallel to the charging power source. In some embodiments, the buffer capacitors are located at the input of an electronic switching element, such as a transistor (e.g., Metal-Oxide-Semiconductor Field-Effect Transistor (MOSFET) or Insulated Gate Bipolar Transistor (IGBT)), or switching module.

In some embodiments, one or more buffer capacitors are connected in parallel with the charging source at the input of an electronic switch. These capacitors store energy that is discharged into the battery during each pulse. This configuration allows the pulse voltage to remain substantially constant and allows the use of power supplies that do not need to supply the full instantaneous current of each pulse.

Maintaining constant pulse voltage through capacitor buffering significantly reduces stress on the battery-management system (BMS) and allows the charging process to proceed without large transient fluctuations in terminal voltage.

After each energy pulse is delivered, energy transfer is paused. During this interval, the system monitors the first derivative of battery terminal voltage (dV/dt). When dV/dt approaches zero, the battery has completed internal redistribution of ions and is ready to accept the next energy pulse efficiently.

The combination of dI/dt-based pulse termination and dV/dt-based pause termination makes the system self-regulating and adaptive, automatically adjusting pulse timing and duration based on real-time electrochemical conditions within the battery.

In some embodiments, a capacitor or capacitor bank is positioned at the output of the electronic switch, connected in parallel with the battery. Preferably, the internal resistance of this capacitor bank is equal to or lower than the internal resistance of the battery, enabling effective buffering of transient currents and assisting in smoothing the pulse waveform.

Further, by repeatedly delivering short, sharp voltage pulses, the system according to embodiment of the present invention enables high instantaneous charging voltage while keeping average charging current low and average charging voltage of the battery 25 within predetermined parameters. This minimizes electrolyte decomposition, gas evolution, and other electrochemical degradation mechanisms typically associated with prolonged high-voltage charging. The approach is supported by the experimental observations reported in the pulse-charge technical evaluation, which note that sharp pulses allow high-voltage application while avoiding detrimental electrolysis phenomena in the electrolyte (shown in FIG. 2).

In some embodiments, at the output of the electronic switch, i.e., at the point of connection to the battery, a capacitor or capacitor bank is connected in parallel with the lithium-ion battery. The nominal voltage rating of this capacitor bank is preferably equal to or greater than the nominal voltage of the buffer capacitors.

The internal resistance of the capacitor or capacitor bank is preferably equal to or less than the internal resistance of the battery. This configuration ensures that the capacitor bank can efficiently absorb and release charge, helping to smooth transient current spikes, reduce noise, and assist in maintaining a stable terminal voltage across the battery during high-frequency energy-pulse operation.

In some embodiments, the combination of buffer capacitors, output capacitors, and pulsed energy transfer creates a controlled energy-delivery system capable of restoring battery capacity at exceptionally high rates while producing only minimal temperature rise. The reduced heating allows high-voltage, low-current charging to proceed without causing degradation typically associated with high-current fast-charging techniques.

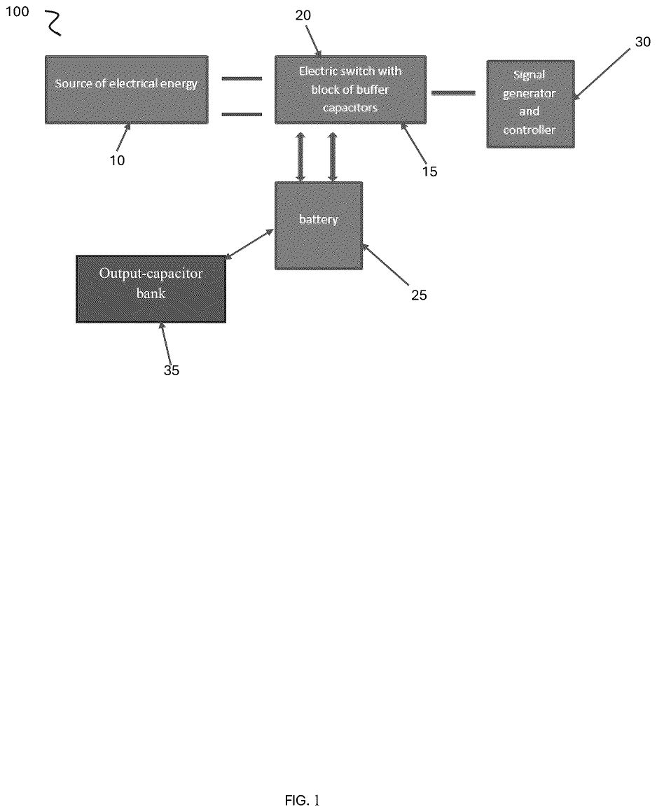

FIG. 1 illustrates an exemplary block diagram of a pulsed-charging system 100 configured to implement the method of the present invention. As shown, the system 100 comprises an external electrical-energy source 10, which may include an AC/DC converter, DC/DC converter, or high-voltage battery pack.

The output of the energy source is electrically connected to a buffer-capacitor module 15. The buffer-capacitor module 15 can have a single high-capacitance element or a bank of capacitors arranged in parallel or series-parallel configurations to achieve desired capacitance and voltage characteristics.

The buffer-capacitor module 15 provides a stable and readily available energy reservoir for forming high-voltage pulses. The capacitors 15 are connected to the input of an electronic switching element 20. The electronic switching element may be a MOSFET, IGBT, thyristor module, power transistor array, or solid-state switching relay designed to operate at high switching frequencies. The switching element 20 controls the timing, amplitude, and duration of each pulse delivered to a battery 25.

A controller and signal-generation module 30, shown in FIG. 1, governs the operation of the switching element 20. The controller and signal-generation module 30 may include a microcontroller, digital signal processor (DSP), FPGA, or mixed-signal IC configured to measure battery-terminal voltage, pulse-current characteristics, and their respective time derivatives. The controller and signal generator 30 provides precise timing signals to the switching element 20 to initiate and terminate each pulse. The controller 30 employs algorithms to calculate real-time values of dI/dt and dV/dt, and uses these values as criteria to determine the end of the energy-supply interval and the end of the pause interval.

The battery under charge 25 can be electrically connected to the output of the switching element 20. In some embodiments, an output-capacitor bank 35 is connected in parallel with the battery 25 terminals to smooth transient voltage spikes, minimize impedance mismatch between pulses, and ensure stable pulse propagation into the battery. The internal resistance of the output capacitors is preferably equal to or less than the internal resistance of the battery cells to ensure optimal energy buffering.

In operation, the controller 30 commands the switch 20 to close, causing a high-voltage pulse to propagate from the buffer capacitors 15 to the battery 25. The controller 30 monitors the instantaneous current response and calculates the first derivative of current with respect to time (dI/dt). When the first derivative of current with respect to time (dI/dt) approaches zero, indicating that transient capacitive charging effects have stabilized, the controller opens the switch 20, ending the pulse. During the pulse-off interval, the controller 30 monitors battery-terminal voltage and calculates the first derivative of voltage with respect to time (dV/dt). When the first derivative of current with respect to time (dI/dt) approaches zero, indicating voltage stabilization and completion of ionic redistribution within the battery, the controller initiates the next pulse.

In certain embodiments, the duration of each applied charging pulse is controlled based on the dynamic behavior of the pulsed charging current. Specifically, during each pulse interval, the system 100 continuously monitors the charging current supplied to the battery 25 and determines the first derivative of the charging current with respect to time (dI/dt). The pulse duration is selected such that the pulse is terminated at or before the time at which the first derivative of the charging current approaches zero. This condition corresponds to the point at which the transient current response of the battery 25 stabilizes and further energy injection during that pulse becomes inefficient. By limiting the pulse duration in this manner, the system prevents excessive current flow, reduces resistive heating, and ensures that each pulse delivers energy only during an optimal charge-acceptance window.

In some embodiments, although the charging process is performed using discrete high-voltage pulses, the average charging current supplied to the battery 25 over the entire charging cycle remains substantially constant. While instantaneous current may vary during individual pulse and pause intervals, the time-averaged value of the charging current is regulated by the controller 30 to remain within a narrow operating band.

In further embodiments, during each charging pulse, the voltage applied to the battery 25 significantly exceeds the nominal operating voltage of the battery. For example, for a lithium-ion battery having a nominal voltage of approximately 3.7 V, the pulsed charging voltage may be several times greater than the nominal voltage. The application of such elevated pulse voltage creates a strong electric field across the interelectrode region of the battery, which enhances charge injection efficiency and enables rapid energy transfer while maintaining a relatively low average charging current within the battery 25 predetermined parameters. Importantly, because the elevated voltage is applied only during short-duration pulses, long-term overvoltage stress, excessive electrolyte decomposition, and accelerated degradation associated with continuous high-voltage charging are avoided.

Long-term validation studies were conducted to evaluate the effect of the disclosed pulsed-charging system and method on battery capacity retention over repeated charge-discharge cycling. Capacity measurements were taken at multiple cycle intervals and plotted as “Battery Capacity Degradation Over Charge Cycles,” shown in FIG. 2.

The results demonstrate exceptionally low capacity fade, particularly when compared to conventional high-current fast-charging methods. As illustrated in FIG. 2, the baseline capacity of the commercial INR18650-15M 1.5 Ah lithium-ion cell measured approximately 1.482 Ah at Cycle 0. Following 50 cycles, the measured capacity remained approximately 1.471 Ah, corresponding to a reduction of only about 0.7%.

Even after extended cycling, the degradation remained minimal and highly linear. At 100 cycles, capacity measured approximately 1.466 Ah; at 150 cycles, approximately 1.460 Ah; and at 200 cycles, approximately 1.458 Ah. After 250 cycles, the cell retained approximately 1.452 Ah, representing a total capacity loss of less than 2.0% over the entire test window.

Further, in certain embodiments, it was discovered that, when applying high-voltage, short-duration charging pulses to a lithium-ion battery, a portion of the resulting charge transfer occurs through an internal mechanism involving ambipolar diffusion. During each pulse, a voltage significantly greater than the nominal cell voltage (e.g., greater than 3.7 V for a typical lithium-ion cell) is applied across the electrodes. Given that the physical separation between the anode and cathode in many lithium-ion cells is on the order of approximately 10 microns, the instantaneous electric field in the interelectrode region becomes sufficient to ionize the cathode material. This ionization process produces free positive lithium ions and free electrons.

During the subsequent pause interval between pulses, the concentration gradient created by the transient population of free charges causes lithium ions and electrons to diffuse from the cathode toward the anode. This diffusion process, occurring without externally supplied current, constitutes ambipolar diffusion and effectively results in a portion of the battery charging itself internally. The relative proportion of internally diffused charge increases with increasing pulse voltage and decreasing pulse duration.

Experimental results confirm the presence and magnitude of this internal charging mechanism. For example, in one embodiment, a commercial Samsung 18650 lithium-ion battery (1.5 Ah, 3.7 V) was charged using high-voltage pulsed charging at an average pulse voltage of approximately 11 V and an average current of approximately 2.44 A. A full charging cycle from 2.6 V to 4.3 V (0-100% state of charge) was achieved in approximately 13.5 minutes with a temperature increase of only approximately 12° C. During discharge, the battery delivered 1.5 Ah. However, only approximately 0.55 Ah was supplied from the external source (2.44 A ×13.5 min/ 60 =0.55 Ah). Thus, approximately 0.95 Ah of the total recovered capacity was attributable to internal ambipolar diffusion. In other words, the battery received approximately 6.04 Wh during charging and delivered approximately 5.55 Wh during discharge.

These findings demonstrate that the disclosed pulsed-charging system enables the battery to obtain a substantial portion of its stored charge through internal diffusion processes, thereby reducing thermal load, reducing external current demand, and contributing to the overall novelty and efficiency of the charging method.

This rate of degradation is significantly lower than the degradation typically observed in lithium-ion cells subjected to conventional fast-charging techniques, where high current loads and elevated electrode polarization commonly accelerate capacity fade. The data indicate that the high-voltage, low-current pulsed charging mechanism of the present invention reduces internal resistance growth, suppresses thermal stress, and limits electrolyte decomposition, thereby extending cell longevity.

The embodiments of the present invention results in no observable damage, malfunction, or abnormality in cells subjected to repeated fast-charging cycles. The combined evidence supports that the disclosed charging method is capable of achieving rapid charging while preserving long-term electrochemical integrity, confirming its suitability for demanding applications such as electric-vehicle energy systems.

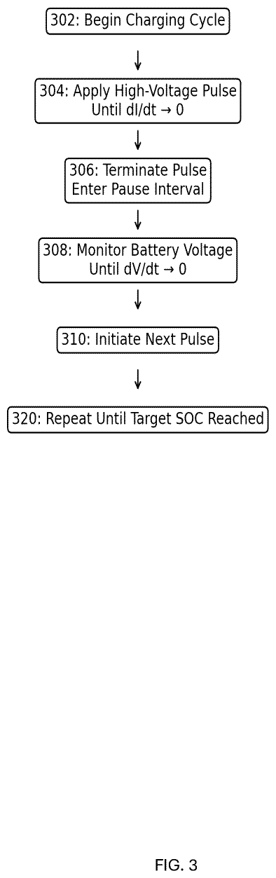

Method 300, shown in FIG. 3, illustrates an embodiment of the pulse-periodic charging process described herein. The method begins at step 302, where a charging cycle is initiated by activating the controller 30 and engaging the electronic switch 20 and measurement circuitry of the controller module. At this stage, the system 100 can establish communication with the battery-management system, if present, and initializes derivative-monitoring routines for both current and voltage.

At step 304, the system 100 applies a high-voltage, low-current charging pulse to the battery. The pulse is formed by discharging the buffer capacitors 15 through the controlled switching element 20. During this pulse, the controller 30 continuously measures instantaneous charging current and computes its first derivative, dI/dt, in real time. The pulse interval continues only until dI/dt approaches zero, which indicates that the transient capacitive and interfacial charge-acceptance response of the battery has stabilized and that further current flow would no longer efficiently contribute to energy transfer.

When the controller detects that the derivative dI/dt has reached the defined threshold, the method proceeds to step 306, in which the electronic switch is opened and the pulse is terminated. The system 100 then enters a pause interval during which no energy is supplied to the battery 25. This pause interval enables, for example, the battery 25 to undergo internal ionic redistribution and equilibrium relaxation, allowing electrode potentials and internal charge distributions to stabilize.

During the pause interval in step 308, the controller 30 measures the instantaneous battery voltage and computes its first derivative, dV/dt. The pause continues until dV/dt approaches zero, indicating that the battery has completed its transient voltage recovery and is again capable of efficiently accepting energy. Only once this stabilization condition is met does the system proceed.

At step 310, the controller 30 initiates the next high-voltage pulse by closing the switch and discharging the buffer capacitors 15 again, thereby beginning a new energy-supply interval. The system again measures the derivative dI/dt to determine the precise moment to terminate the pulse. This adaptive cycle-pulse, pause, pulse, pause-forms the core periodic structure of the charging algorithm.

Steps 304-310 repeat continuously throughout step 320, during which the pulsed charging sequence is repeatedly executed until the desired state of charge (SOC) is reached. Because each pulse transfers energy at a high voltage but low average current, the system delivers rapid energy input while minimizing resistive heating inside the battery. By ensuring that each pulse begins only when the battery is ready to accept charge (dV/dt≈0) and ends when transient current stabilization occurs (dI/dt≈0), Method 300 tightly controls thermal behavior and reduces battery degradation compared to conventional high-current fast-charging methods.

The pulsed-charging system 100 and method 300 of the present invention may be implemented in a variety of hardware configurations depending on the intended power level, battery type, and application environment. In one implementation, the system 100 can incorporate a microcontroller-based control unit that operates at moderate switching speeds and includes integrated analog-to-digital converters for real-time voltage and current measurement. The microcontroller executes software routines that periodically sample the instantaneous battery voltage and charging current, compute the first derivatives dI/dt and dV/dt using digital differentiation techniques, and determine the precise start and end of each charging pulse and pause interval. The microcontroller further generates gate-drive signals for the switching element, such as a MOSFET or insulated-gate bipolar transistor (IGBT), thereby controlling both the amplitude and duration of the high-voltage pulses delivered to the battery. This type of implementation is particularly suitable for low-to-medium power charging systems, such as personal electronics, light electric vehicles, electric tools, drone batteries, or modular battery packs where compact and low-cost control electronics are desirable.

In higher-power applications, such as electric-vehicle battery systems or grid-level storage modules, the pulsed-charging system 100 can be implemented using a digital signal processor (DSP) or a field-programmable gate array (FPGA). These devices support substantially higher sampling rates, faster control loops, and more sophisticated filtering algorithms for estimating derivatives of voltage and current with greater precision. A DSP-based system may implement advanced signal-processing techniques such as Kalman filtering, adaptive smoothing, or digital compensation algorithms to ensure robust measurement of dI/dt and dV/dt even under high-frequency noise conditions. An FPGA-based system, by contrast, may generate fast and highly accurate switching-control signals with sub-microsecond precision, enabling very sharp and controlled pulse shapes. Such implementations allow the system to deliver high-voltage pulses, for example, 20 V, or even higher depending on module configuration, while maintaining low average current, thereby enabling extremely rapid charging with minimal heat generation.

For large multi-cell battery packs, such as those used in electric vehicles, industrial storage units, or marine or aerospace power systems, the method 300 may be implemented using a modular multi-channel architecture. In such an embodiment, each module is responsible for delivering controlled charging pulses to an individual cell or to a parallel group of cells. Each module includes its own buffer-capacitor set, switching element, measurement circuit, and localized controller. These modules communicate over an internal network, such as a CAN bus, LIN bus, RS-485 link, or other robust communication interface, with a central supervisory controller that coordinates pulse sequences across the entire pack. This modular architecture allows the charger to apply pulses simultaneously or in a staggered sequence to different sections of the pack, reduces pack-wide thermal gradients, improves uniformity of charge acceptance among cells, and supports dynamic balancing strategies during fast charging. Such a distributed implementation greatly enhances safety, scalability, and redundancy, enabling the system to handle hundreds or thousands of cells arranged in complex series-parallel configurations.

In another embodiment, the charging system 100 can integrate directly with high-voltage infrastructure, such as DC fast-charging stations, renewable-energy storage nodes, or grid-connected power-conversion units. In this implementation, the external power supply may itself be a high-voltage DC bus or a bidirectional high-power AC/DC converter. The buffer-capacitor bank may consist of industrial-grade film capacitors, supercapacitors, or hybrid electrochemical capacitors capable of storing and releasing large amounts of energy in extremely short intervals. The switching elements may include high-power IGBT modules, silicon carbide (SiC) MOSFETs, or gallium nitride (GaN) transistors optimized for high-frequency and high-voltage operation. This configuration supports very fast charging of large batteries, such as electric-vehicle packs, electric buses, truck fleets, or stationary energy-storage systems. The pulse-charging modules can be integrated into charging stations as modular add-ons, enabling existing infrastructures to deliver extremely rapid charging without substantially increasing average current demand or overheating battery packs.

In all implementations, the system 100 may interface with an existing battery-management system (BMS) to ensure compliance with safety limits and operational constraints. The charger may receive data from the BMS, including cell temperature, voltage boundaries, impedance values, state-of-charge thresholds, and state-of-health indicators. The controller may adjust pulse amplitude or timing in response to BMS feedback, and the BMS may temporarily override the charger if thermal or electrical safety limits are approached. This integrated communication ensures that the pulsed-charging method operates safely and effectively across a wide range of ambient temperatures, operating conditions, and battery chemistries.

The output-capacitor bank connected in parallel with the battery may be implemented using a variety of capacitor technologies depending on frequency response, energy density, and thermal considerations. In some configurations, high-frequency ceramic capacitors may be arranged to filter high-frequency noise and stabilize pulse transitions. In other embodiments, supercapacitors or hybrid ultracapacitors may be used to provide large instantaneous energy buffering capability, particularly in high-power systems. Film capacitors with low equivalent series resistance (ESR) may also be used where stability and durability under high-voltage pulsing conditions are critical. These capacitors ensure that each pulse maintains its designed profile even in the presence of dynamic load changes or variations in cell impedance during the charging process.

Collectively, these various implementations demonstrate that the pulsed-charging system described herein is flexible and scalable across multiple use cases, ranging from small consumer devices to full-scale electric vehicles and industrial power-storage installations. The system's ability to deliver high-voltage pulses with minimal average current, combined with dynamic control based on real-time derivative measurements, enables rapid charging while minimizing degradation and preserving the electrochemical integrity of the battery.

The foregoing detailed description of the embodiments is used to further clearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A pulsed-charging system for charging a battery, the system comprising:
an external electrical-energy source configured to supply electrical energy at a charging voltage greater than a nominal operating voltage of the battery;
a buffer-capacitor module electrically connected to the external electrical-energy source and configured to store electrical energy and discharge the stored electrical energy as a high-voltage charging pulse;
an electronic switching element having an input electrically connected to the buffer-capacitor module and an output electrically connected to the battery, the electronic switching element configured to selectively apply the high-voltage charging pulse to the battery; and
a controller configured to:
monitor a charging current delivered to the battery and determine a first derivative of the charging current with respect to time (dI/dt);
terminate the high-voltage charging pulse when the first derivative of the charging current reaches approximately zero;
monitor a battery terminal voltage during a pause interval following termination of the charging pulse and determine a first derivative of the voltage with respect to time (dV/dt); and
initiate a subsequent high-voltage charging pulse when the first derivative of the battery terminal voltage reaches approximately zero,
wherein a duration of the pulse interval is less than or equal to a time required for the first derivative of the charging current to reach approximately zero.

2. The system of claim 1, wherein the buffer-capacitor module comprises one or more capacitors arranged in parallel or series-parallel configurations.

3. The system of claim 1, wherein the electronic switching element comprises at least one Metal-Oxide-Semiconductor Field-Effect Transistor (MOSFET) or Insulated Gate Bipolar Transistor (IGBT), thyristor module, silicon-carbide switch, gallium-nitride transistor, or solid-state relay.

4. The system of claim 1, further comprising an output-capacitor bank connected in parallel with the battery at a point of connection of the electronic switching element.

5. The system of claim 4, wherein the output-capacitor bank has an internal resistance equal to or less than an internal resistance of the battery.

6. The system of claim 1, wherein the controller comprises a microcontroller, digital signal processor (DSP), field-programmable gate array (FPGA), or mixed-signal integrated circuit.

7. The system of claim 1, wherein the controller executes a pulse-pause sequence, the pulse ending when the first derivative of the charging current with respect to time (dI/dt) is about 0 and the pause ending when the first derivative of the voltage with respect to time (dV/dt) is about 0.

8. The system of claim 1, configured for use with a lithium-ion, lithium-polymer, nickel-metal hydride, nickel-cadmium, rechargeable alkaline, or other chemical current sources.

9. The system of claim 1, wherein the system is configured to reduce temperature rise during charging by at least 50% compared to a conventional high-current constant-current fast-charging method.

10. The system of claim 1, wherein the controller is configured to communicate with a battery-management system (BMS).

11. The system of claim 1, implemented in a multi-channel modular architecture where each module is configured to pulse-charge an individual cell or cell group within a multi-cell battery pack.

12. A method for charging a battery, the method comprising:
supplying electrical energy from an external source to a buffer-capacitor module;
discharging the electrical energy stored in the buffer-capacitor module as a high-voltage charging pulse through an electronic switching element to the battery;
monitoring a charging current delivered to the battery and determining a first derivative of the charging current with respect to time (dI/dt);
terminating the high-voltage charging pulse when the first derivative of the charging current reaches approximately zero;
pausing energy delivery and monitoring a battery terminal voltage to determine a first derivative of the voltage with respect to time (dV/dt); and
initiating a subsequent high-voltage charging pulse when the first derivative of the battery terminal voltage reaches approximately zero,
wherein the battery is charged to a target state of charge by repeating the steps, and
wherein a duration of the pulse interval is less than or equal to a time required for the first derivative of the charging current to reach approximately zero.

13. The method of claim 12, wherein the average charging current supplied to the battery over an entire charging cycle remains substantially constant.

14. The method of claim 12, wherein the first derivative of the charging current with respect to time (dI/dt) is computed in real time from sampled current measurements.

15. The method of claim 12, wherein the pause interval continues until ionic redistribution within the battery has stabilized, as indicated by the first derivative of the voltage with respect to time (dV/dt) being about 0.

16. The method of claim 12, wherein heat generation during charging is reduced by at least 3 times compared to conventional 6 C fast-charging.

17. The method of claim 12, wherein the battery exhibits less than 2% capacity degradation after at least 340 cycles of pulsed charging.

18. The method of claim 12, applied to a multi-cell battery pack, wherein each cell or cell group is charged by a corresponding pulse-generation module.

19. A method for charging a rechargeable battery, comprising:
applying, during a pulse interval, a charging voltage across the battery that is greater than a nominal operating voltage of the battery by a factor sufficient to generate an electric field across an interelectrode spacing that ionizes at least a portion of a cathode material of the battery;
producing a population of free lithium ions and electrons within the interelectrode region;
terminating the pulse interval and initiating a pause interval during which no external current is supplied to the battery; and
causing the free lithium ions and electrons to migrate from the cathode toward the anode via ambipolar diffusion during the pause interval, thereby increasing a state of charge of the battery independent of externally supplied current.

20. The method of claim 19, wherein the charging voltage applied during the pulse interval is at least three times greater than the nominal cell voltage of the battery.

21. The method of claim 19, wherein the duration of the pulse interval is less than 10 milliseconds.
